(19) United States
(12) Patent Application Publication
(10) Pub. No.: US 2007/0112159 A1
(43) Pub. Date: May 17, 2007

(54) Process for the production of polypropylene from propane

(76) Inventors: Heinz Boelt, Wolfratshausen (DE); Peter Matthias Fritz, Unterhaching (DE); Peter Ulbrich, Pullach (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/442,606

(22) Filed: May 30, 2006

Related U.S. Application Data
(60) Provisional application No. 60/752,398, filed on Dec. 22, 2005.
(60) Provisional application No. 60/752,401, filed on Dec. 22, 2005.

(30) Foreign Application Priority Data
Nov. 11, 2005 (DE) DE 102005054287.5
Nov. 11, 2005 (DE) 102005054288.3

(51) Int. Cl. C08F 110/06

(52) U.S. Cl. 526/351

(57) ABSTRACT

The invention relates to a process for the production of polypropylene with a propane-dehydrogenation stage and a polymerization stage, whereby a degassing stream is obtained, characterized in that the degassing stream is used as a feedstock stream for the propane-dehydrogenation stage.

### RELATED APPLICATION

This application claims the benefit under 35 U.S.C. 119(e) of Provisional Application 60/752,398 filed Dec. 22, 2005. Also, this invention may be related to our concurrently filed application entitled “Process For The Preparation Of Polyethylene” based on Provisional Application 60/752,401 filed Dec. 22, 2005 and German application DE 102005054287.5 filed Nov. 11, 2005.

### SPECIFICATION

This invention relates to a process for the production of polypropylene with a propane-dehydrogenation stage and a polymerization stage, wherein a degassing stream is obtained.

Processes for polypropylene production are known in which propane is converted into propylene via a propane-dehydrogenation stage. The propylene is subsequently polymerized in a polymerization unit to form polypropylene. In a conventional polymerization unit, a relatively large degassing stream is obtained in the degassing of the polypropylene product. The latter is usually worked up in the polymerization unit in an expensive processing unit that provides a seal, condensation, propane/propylene separation and additional steps. The propylene that is recovered in this case is used in the polymerization unit again as a recycle stream. The processing unit that is described for conventional working-up of the degassing stream is expensive to build and therefore gives rise to high investment costs.

Processes for producing propylene from propane and polypropylene from propylene are well known.

At typical degassing stream from a polypropylene plant may have the following composition (wt %):

Hydrogen 0.01 - 1

Nitrogen 0.01 - 25

Ethylene 0.01 - 20

Ethane 0.01 - 1

Propylene 40 - 80

Propane 5 - 20

One object of this invention is to make available a process for the production of polypropylene from propane that is simplified and more economical compared to the prior art.

Upon further study of the specification and appended claims, other objects and advantages of the invention will become apparent.

### SUMMARY OF THE INVENTION

These objects are thus achieved in that the degassing stream is used as a feedstock stream for the propane-dehydrogenation stage. The degassing stream from the polymerization stage is advantageously returned directly to the propane-dehydrogenation stage and is worked up there. The expensive processing group that consists of compressor, condenser, propane/propylene separation, etc., as described above thus is unnecessary. The investment costs of the entire unit (propane-dehydrogenation stage and polymerization stage) are therefore advantageously reduced.

Typically nitrogen is used in the degassing step, which then will be present in the vent gas stream. In the case that the vent gas stream of a polypropylene plant will be routed to a propane dehydrogenation plant, the nitrogen ends up in the tail gas fraction. This fraction will be utilized as fuel gas, therefore a build-up of nitrogen is avoided. Whereas the recycling of the vent stream to the propane-dehydrogenation plant increases the load on the separation section of plant, this increase is comparably small and the separation section can easily be scaled up to accommodate same.

According to an advantageous further development of the invention and before feeding as a feedstock stream into the propane-dehydrogenation stage, the degassing stream is run over an adsorber that is suitable for removing catalyst poisons and other undesirable accompanying substances e.g. catalyst residues which are generally organometallic compounds. There are several known adsorbents, e.g. alumina and equivalents thereof which can be used in the invention.

According to another advantageous further development of the invention and before feeding as a feedstock stream into the propane-dehydrogenation stage, the degassing stream is subjected to a scrubbing that is suitable for removing catalyst poisons residues and other undesirable accompanying substances. Scrubbing agents include but are not limited to water and/or caustic solutions.

Both embodiments have the purpose of removing substances from the degassing stream that could be deleterious to the operation of the propane-dehydrogenation stage.

It is also to be noted that the propane-dehydrogenation stage and propylene polymerization stage are both old and well known to those in the field and there are many variations described in the patent and technical literature. Accordingly, this invention is applicable to such processes where a degasifying step is employed in the polymerization stage.

The entire disclosures of all applications, patents and publications, cited herein and of corresponding German application No. 102005054288.3, filed Nov. 11, 2005 and U.S. Provisional Application 60/752,398 filed Dec. 22, 2005 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. In a process for the production of polypropylene, comprising conducting a propane-dehydrogenation stage to obtain propylene and a polymerization stage to obtain polypropylene wherein a degassing stream is recovered from the polymerization stage, the improvement comprising passing the degassing stream as a feedstock stream for the propane-dehydrogenation stage.

2. A process according to claim 1, wherein before passing the degassing stream as feedstock into the propane-dehydrogenation stage, the degassing stream is passed over an adsorbent for removing at least one of catalyst poisons, catalyst residues or other deleterious substances.

3. A process according to claim 1, wherein before the passing the degassing streams as a feedstock into the propane-dehydrogenation stage, the degassing stream is subjected to a scrubbing step for removing at least one of catalyst poisons or residues or other undesirable accompanying substances.

4. A process according to claim 2, wherein before the passing the degassing streams as a feedstock into the propane-dehydrogenation stage, the degassing stream is subjected to a scrubbing step for removing at least one of catalyst poisons or residues or other undesirable accompanying substances.

5. A process according to claim 1, comprising venting the polymerization stage with nitrogen, passing the resultant vent gas to the propane dehydrogenation plant, and removing from the propane-hydrogenation stage a tail gas containing the nitrogen and residual combustibles.

6. A process according to claim 5, wherein before passing the degassing stream as feedstock into the propane-dehydrogenation stage, the degassing stream is passed over an adsorbent for removing at least one of catalyst poisons, catalyst residues or other deleterious substances.

7. A process according to claim 5, wherein before the passing the degassing streams as a feedstock into the propane-dehydrogenation stage, the degassing stream is subjected to a scrubbing step for removing at least one of catalyst poisons or residues or other undesirable accompanying substances.

8. A process according to claim 5, further comprising passing said tail gas as fuel to a unit for combusting said fuel gas.
